(19) United States
(12) Patent Application Publication
(10) Pub. No.: US 2016/0283950 A1
(43) Pub. Date: Sep. 29, 2016

(54) STORAGE MEDIUM, FACILITY INSPECTION SUPPORT METHOD, AND FACILITY INSPECTION SUPPORT APPARATUS

(71) Applicant: FUJITSU LIMITED, Kawasaki-shi (JP)

(72) Inventors: Yuta SHIOIRI, Kawasaki (JP); IWAO KAKEGAWA, Kawasaki (JP); Toshiyuki Maruyama, Kawasaki (JP); Yoko Saito, Kawasaki (JP)

(73) Assignee: FUJITSU LIMITED, Kawasaki-shi (JP)

(21) Appl. No.: 15/173,825

(22) Filed: Jun. 6, 2016

Related U.S. Application Data
(63) Continuation of application No. PCT/JP2013/083506, filed on Dec. 13, 2013.

(51) Int. Cl. G06Q 30/00; H04L 12/58; G06F 3/0481; G06Q 10/10; G06F 3/0484

(52) U.S. Cl. CPC G06Q 30/018; G06Q 10/103; G06F 3/04842; G06F 3/04817; H04L 51/08; H04L 51/20

(57) ABSTRACT

A non-transitory computer-readable storage medium stores a program that causes a computer to execute a process. The process includes displaying pointers indicating inspection points on a map of a facility, receiving an operation that selects one or more of the displayed pointers, when multiple pointers are selected from the displayed pointers, generating a message including link identifiers for separately referring to inspection results associated with the selected multiple pointers respectively, and sending the generated message to a specified destination.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2013/083506, filed on Dec. 13, 2013, the entire contents of which are incorporated herein by reference.

### FIELD

An aspect of this disclosure relates to a storage medium, a facility inspection support method, and a facility inspection support apparatus.

### BACKGROUND

Japanese Laid-Open Patent Publication No. 2011-186621 discloses a system that supports inspection of facilities in, for example, a factory. The disclosed system records inspection results of inspection points based on, for example, an inspection route.

Here, there is a case where multiple inspectors take turns to perform inspection of facilities. In such a case, the results of inspection performed by one inspector need to be shared by other inspectors. Also, inspection results to be shared need to be always up to date.

However, the disclosed system is not designed to share recorded inspection results by multiple people, and cannot effectively support collaborative inspection work performed by multiple people.

### SUMMARY

According to an aspect of this disclosure, there is provided a non-transitory computer-readable storage medium storing a program that causes a computer to execute a process. The process includes displaying pointers indicating inspection points on a map of a facility, receiving an operation that selects one or more of the displayed pointers, when multiple pointers are selected from the displayed pointers, generating a message including link identifiers for separately referring to inspection results associated with the selected multiple pointers respectively, and sending the generated message to a specified destination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a drawing illustrating an exemplary configuration of a facility inspection support system;

FIG. 2 is a table illustrating an exemplary pin definition database;

FIG. 3 is a table illustrating an exemplary pin record database;

FIG. 4 is a table illustrating an exemplary route definition database;

FIG. 5 is a table illustrating an exemplary route record database;

FIG. 6 is a table illustrating an exemplary map definition database;

FIGS. 7A through 7C are drawings illustrating exemplary maps;

FIG. 8 is a table illustrating an exemplary report database;

FIG. 9 is a block diagram illustrating an exemplary hardware configuration of a terminal;

FIG. 10 is a drawing illustrating an exemplary functional configuration of a facility inspection support system;

FIG. 11 is a flowchart illustrating an exemplary process performed by a terminal and a server;

FIG. 12 is a sequence chart illustrating an exemplary process of sharing inspection results;

FIG. 13 is a drawing illustrating an exemplary pin selection screen;

FIG. 14 is a drawing illustrating an exemplary message screen;

FIG. 15 is a flowchart illustrating an exemplary process of reordering link identifiers;

FIG. 16 is a flowchart illustrating an exemplary process of displaying inspection results;

FIG. 17 is a drawing illustrating an exemplary message reception screen;

FIG. 18 is a drawing illustrating an exemplary inspection result screen displayed when a link identifier is a route ID indicating an inspection route; and

FIG. 19 is a drawing illustrating an exemplary inspection result screen displayed when link identifiers are pin IDs indicating inspection pins.

### DESCRIPTION OF EMBODIMENTS

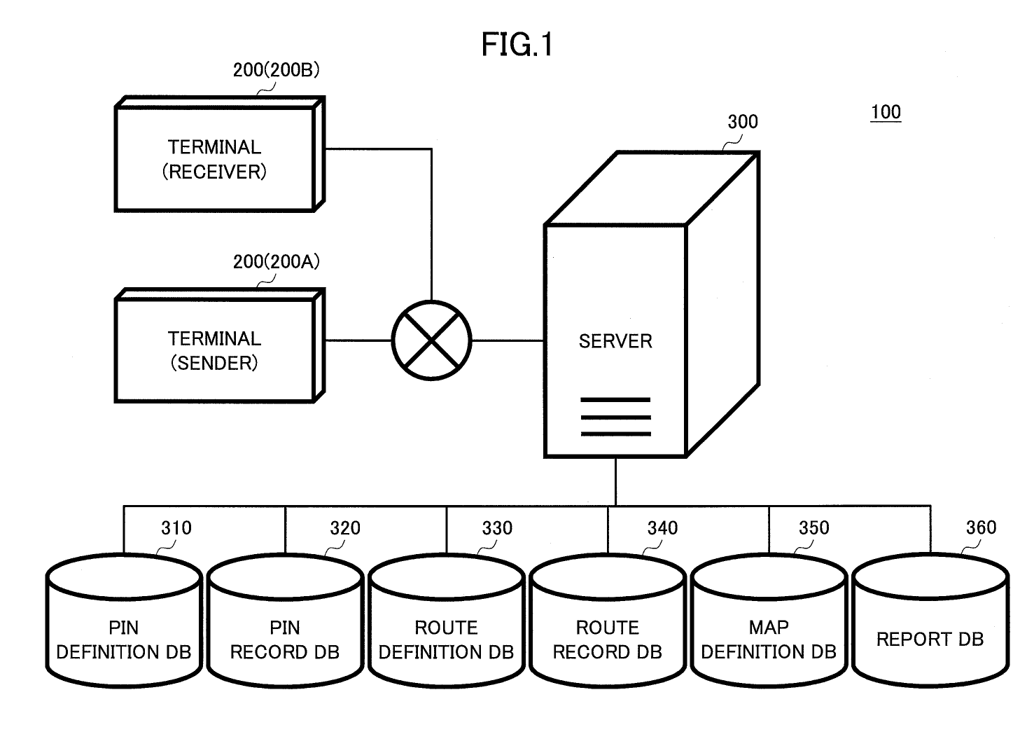

Embodiments of the present invention are described below with reference to the accompanying drawings. FIG. 1 is a drawing illustrating an exemplary configuration of a facility inspection support system 100.

The facility inspection support system 100 may include multiple terminals 200 (which may be referred to as “terminal 200” in the singular form when it is not necessary to distinguish them) and a server 300 that are connected to each other via a network.

The facility inspection support system 100 supports inspectors to inspect various types of facilities in, for example, a factory or a plant such as a power plant.

The server 300 may include a pin definition database (DB) 310, a pin record database (DB) 320, a route definition database (DB) 330, a route record database (DB) 340, a map definition database (DB) 350, and a report database (DB) 360.

When a facility inspection support program is started by an inspector, the terminal 200 supports inspection work of the inspector. More specifically, the terminal 200 refers to the pin definition database 310, the route definition database 330, and the map definition database 350, and displays pointers (which are hereafter referred to as “pins”) indicating inspection points based on an inspection route. Also, by referring to the pin definition database 310, the terminal 200 displays input screens in the order of inspection to allow the inspector to enter inspection results. Each input screen includes input fields for entering information items corresponding to a pin. When inspection results are entered for all pins included in the inspection route, the terminal 200 sends the inspection results to the server 300 and requests the server 300 to store the inspection results in the pin record database 320 and the route record database 340. In the present embodiment, inspection results indicate values entered on an input screen corresponding to each pin.

As described above, the terminal 200 displays input screens corresponding to pins in the order of inspection and allows an inspector to enter inspection results. Thus, the terminal 200 functions as a facility inspection support apparatus that supports inspection work of an inspector.

Also in the present embodiment, the terminal 200 sends, to another terminal(s) 200, information for referring to inspection results stored in the server 300, and thereby shares the inspection results with the other terminal(s) 200. Below, for descriptive purposes, it is assumed that a terminal 200A is a sending terminal that sends information for referring to inspection results to another terminal, and a terminal 200B is a receiving terminal that receives the information. However, the terminals 200A and 200B may be simply referred to as “terminals 200” when it is not necessary to distinguish them.

In the present embodiment, the information for referring to inspection results may indicate, for example, a location on the server 300 where inspection results are stored. As another example, the information for referring to inspection results may be an identifier associated with inspection results stored in the server 300.

That is, the information for referring to inspection results may be any type of information usable to identify inspection results to be shared by the terminal 200A and the terminal 200B. In the descriptions below, the information for referring to inspection results is referred to as a “link identifier”.

As described above, according to the present embodiment, the facility inspection support system 100 allows the terminal 200A to share inspection results with the terminal 200B, and thereby supports collaborative inspection work performed by multiple inspectors.

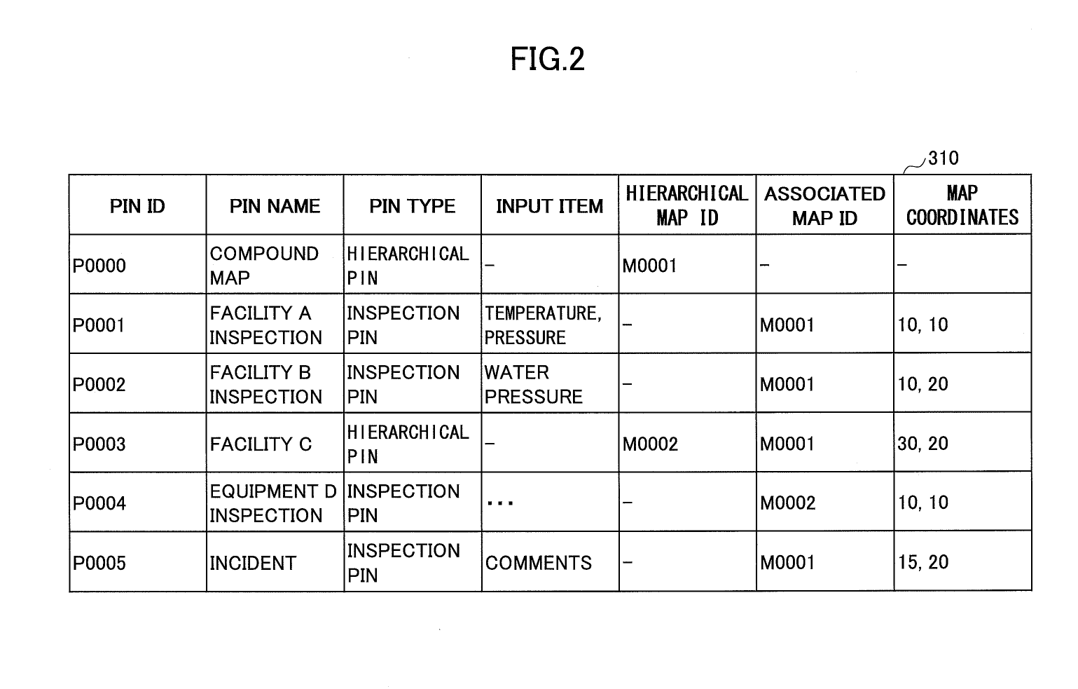

Next, databases included in the server 300 are described with reference to FIGS. 2 through 9.

FIG. 2 is a table illustrating an example of the pin definition database 310.

The pin definition database 310 includes, as information items (fields), a pin ID; and a pin name, a pin type, one or more input items, a hierarchical map ID, an associated map ID, and map coordinates that are associated with the pin ID. In the descriptions below, information items associated with a pin ID in the pin definition database 310 are referred to as “pin information”.

The pin ID is an identifier for identifying a pin. The pin name is the name of a pin. The pin type indicates the type of a pin. In the present embodiment, there are two types of pins: a hierarchical pin and an inspection pin. The hierarchical pin indicates a hierarchical level of a map. The inspection pin indicates an inspection point in a map.

Each input item is an information item input as an inspection result and corresponds to an input field in an input screen. In the present embodiment, one or more input items are associated with and determined for each inspection pin.

The hierarchical map ID is associated with a hierarchical pin, and is a map ID that indicates a map in a hierarchical level indicated by the hierarchical pin. The associated map ID is associated with an inspection pin or a hierarchical pin, and is a map ID that indicates a map (associated map) including the inspection pin or the hierarchical pin. The map coordinates are associated with an inspection pin or a hierarchical pin and indicate a position of the inspection pin or the hierarchical pin in a map including the inspection pin or the hierarchical pin.

In the example of FIG. 2, a pin ID “P0000” indicates a hierarchical pin whose name is “compound map”. The hierarchical pin with the pin ID “P0000” is associated with a map ID “M0001”. A pin ID “P0001” indicates an inspection pin whose name is “facility A inspection”. The inspection pin with the pin ID “P0001” is associated with input items “temperature” and “pressure”, and is located at coordinates (10, 10) in a map with the map ID “M0001”. Hereafter, for brevity, a pin with a pin ID “PXXXX” may be referred to as a pin “PXXXX”, and a map with a map ID “MXXXX” may be referred to as a map “MXXXX”.

Also in the example of FIG. 2, a pin ID “P0003” indicates a hierarchical pin whose name is “facility C”. The hierarchical pin “P0003” belongs to the map “M0001”, is located at coordinates (30, 20), and is also associated with a map ID “M0002”. Thus, the hierarchical pin “P0003” defines a hierarchy of the map “M0001” and the map “M0002”.

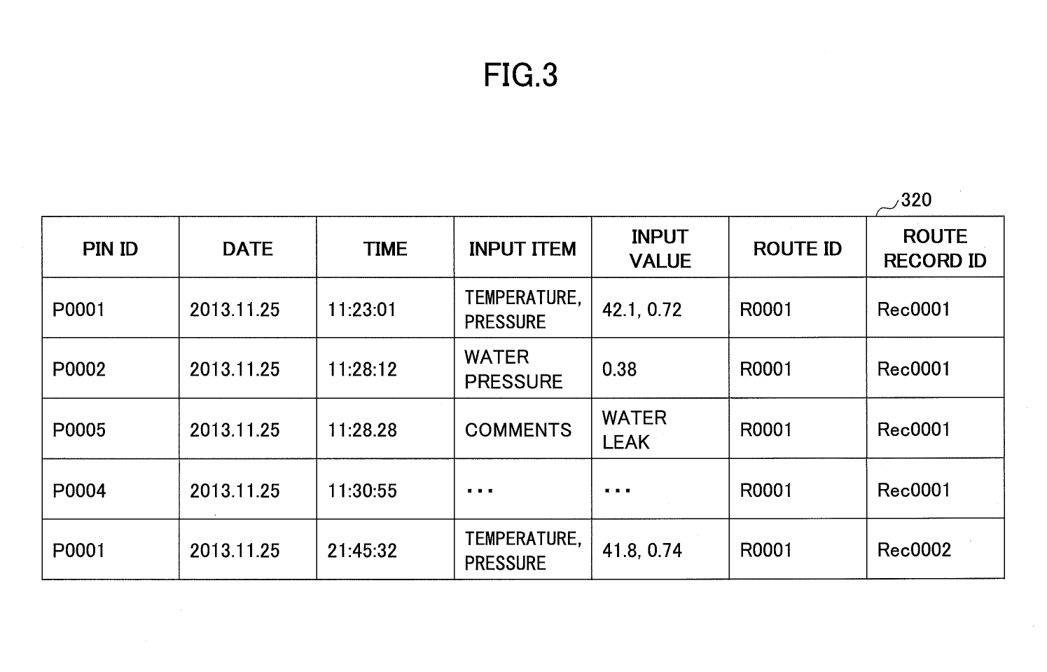

FIG. 3 is a table illustrating an example of the pin record database 320.

The pin record database 320 stores inspection results for each inspection pin.

The pin record database 320 includes, as information items (fields), a pin ID; and a date, a time, one or more input items, one or more input values, a route ID, and a route record ID that are associated with the pin ID. In the descriptions below, information items associated with a pin ID in the pin record database 320 are referred to as “pin record information”.

In the pin record database 320 of the present embodiment, the date and the time indicate when an input value is entered in an input item. The input item indicates an information item to be entered as an inspection result for the corresponding inspection pin, and the input value indicates an actual value entered for the input item.

The route ID is an identifier for identifying an inspection route including the inspection pin. The route record ID is an identifier for identifying inspection results of the corresponding inspection route.

In the example of FIG. 3, as an inspection result of an inspection pin “P0002”, an input value “0.38” is entered for an input item “water pressure” recorded at 11:28:12 on 2013/11/25. The inspection pin “P0002” is included in an inspection route with a route ID “R0001”, and the inspection result of the inspection pin “P0002” is included in a route record identified by a route record ID “Rec0001”.

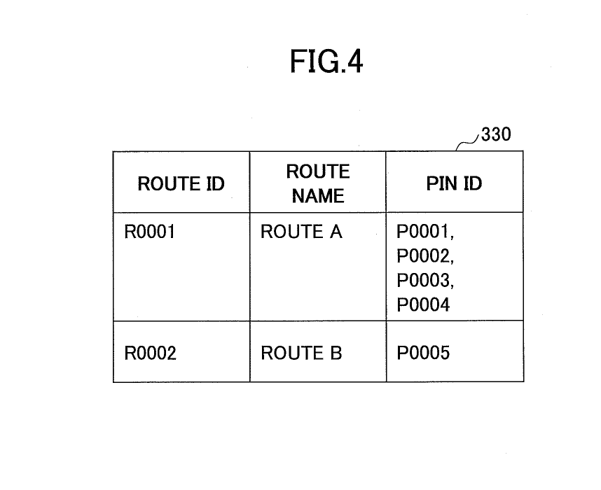

FIG. 4 is a table illustrating an example of the route definition database 330.

The route definition database 330 includes, as information items (fields), a route ID; and a route name and one or more pin IDs that are associated with the route ID. In the descriptions below, information items associated with a route ID in the route definition database 330 are referred to as “route information”.

In the route definition database 330 of the present embodiment, a route ID and one or more pin IDs are associated with each other to indicate that pins with the pin IDs are included in an inspection route identified by the route ID.

In the example of FIG. 4, an inspection route “route A” with a route ID “R0001” includes inspection pins with pin IDs “P0001”, “P0002”, and “P0004” and a hierarchical pin with a pin ID “P0003”.

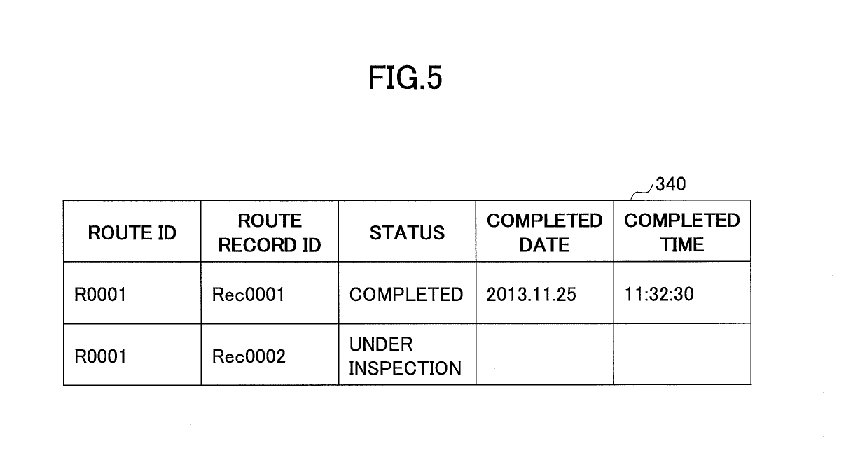

FIG. 5 is a table illustrating an example of the route record database 340.

The route record database 340 includes, as information items (fields), a route ID; and a route record ID, status, a completed date, and a completed time that are associated with the route ID. In the descriptions below, information items associated with a route ID in the route record database 340 are referred to as “route record information”.

In the route record database 340, the status indicates the status of inspection of an inspection route indicated by the corresponding route ID. The completed date and the completed time indicate when the inspection of the inspection route indicated by the route ID is completed.

In the example of FIG. 5, the inspection of an inspection route with a route ID “R0001” is completed at 11:32:30 on 2013/11/25 and its inspection results are recorded in association with a route record ID “Rec0001”.

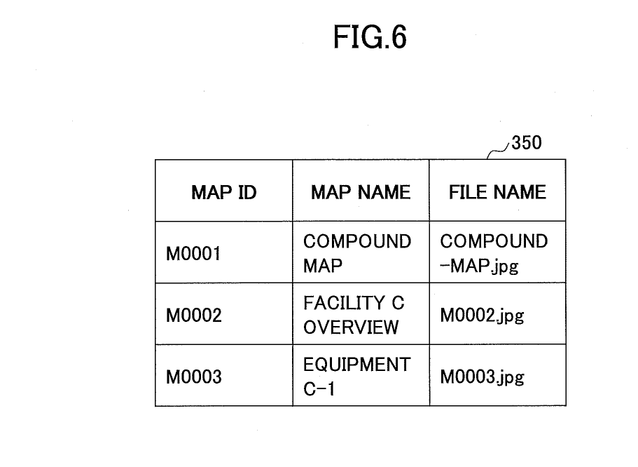

FIG. 6 is a table illustrating an example of the map definition database 350.

The map definition database 350 includes, as information items (fields), a map ID; and a map name and a file name that are associated with the map ID. In the descriptions below, information items associated with a map ID in the map definition database 350 are referred to as “map information”.

The map name is the name of a map, and the file name indicates a file used by the terminal 200 to display the map.

In the example of FIG. 6, a map with a map ID “M0001” has a name “compound map”, and the name of a file used to display the map is “compound-map.jpg”.

The map definition database 350 of the present embodiment stores files representing maps in different hierarchical levels. For example, the map definition database 350 may store a file of a map of the entire area of a factory to be inspected, a file of a map of a facility in the factory, and a file of a map of equipment in the facility.

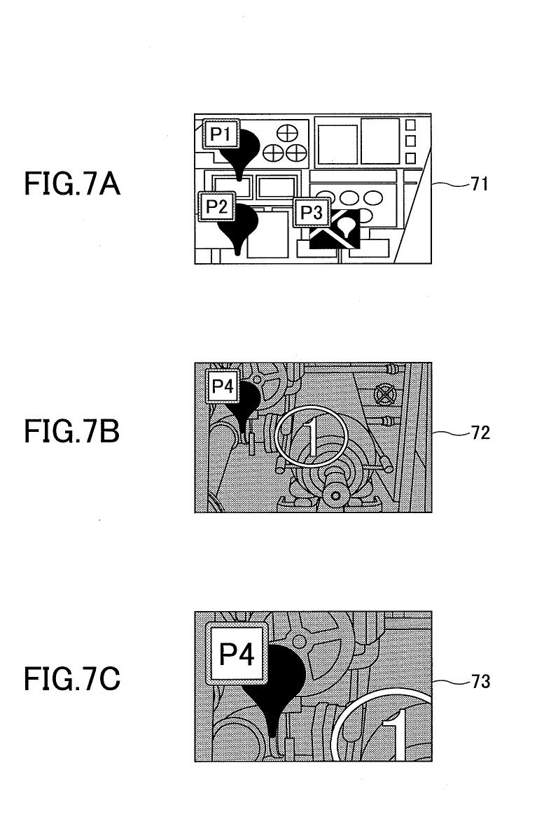

The hierarchy of maps is described with reference to FIGS. 7A through 7C. FIGS. 7A through 7C are drawings illustrating exemplary maps. FIG. 7A illustrates a map 71 in a first hierarchical level, FIG. 7B illustrates a map 72 in a second hierarchical level, and FIG. 7C illustrates a map 73 that is an enlarged view of an inspection point in the second hierarchical level.

The map 71 of FIG. 7A represents an area where various facilities are present. The map 71 is, for example, the compound map “M0001” stored in the map definition database 350. On the map 71, a hierarchical pin P3, an inspection pin P1, and an inspection pin P2 are displayed. In the present embodiment, hierarchical pins and inspection pins are preferably displayed on a map using icon images corresponding to their pin types.

The map 72 of FIG. 7B is in a hierarchical level below the hierarchical level of the map 71, and is a schematic view of a facility in an area indicated by the hierarchical pin P3 in the map 71. That is, the map 72 represents details of the area indicated by the hierarchical pin P3 in the map 71. The map 72 is, for example, the map “M0002” of the facility C stored in the map definition database 350. On the map 72, an inspection pin P4 is displayed. The inspection pin P4 indicates equipment to be inspected in the facility represented by the map 72.

The map 73 of FIG. 7C is an enlarged view of an inspection point in the map 72. For example, the map represents the layout of equipment that is to be inspected and indicated by the inspection pin P4.

Thus, in the present embodiment, an image illustrating more details of an inspection point is displayed by the terminal 200 in the lower level of hierarchy. In the present embodiment, the hierarchical relationship between maps stored in the map definition database 350 is indicated by, for example, pins associated with the maps and an inspection route including the pins.

The map definition database 350 stores, for example, names of files (e.g., image data) of the map 71, the map 72, and the map 73 in association with map IDs and map names. The actual files of the maps 71, 72, and 73 may be stored in the map definition database 350 or in another storage device.

The map definition database 350 may also store information indicating the hierarchical relationship between maps in association with map IDs. For example, the map “M0002” is in a hierarchical level that is one level below the hierarchical level of the map “M0001”. In this case, information “M0001-1” indicating the hierarchical level one level below the hierarchical level of the map “M0001” may be associated with the map ID “M0002”.

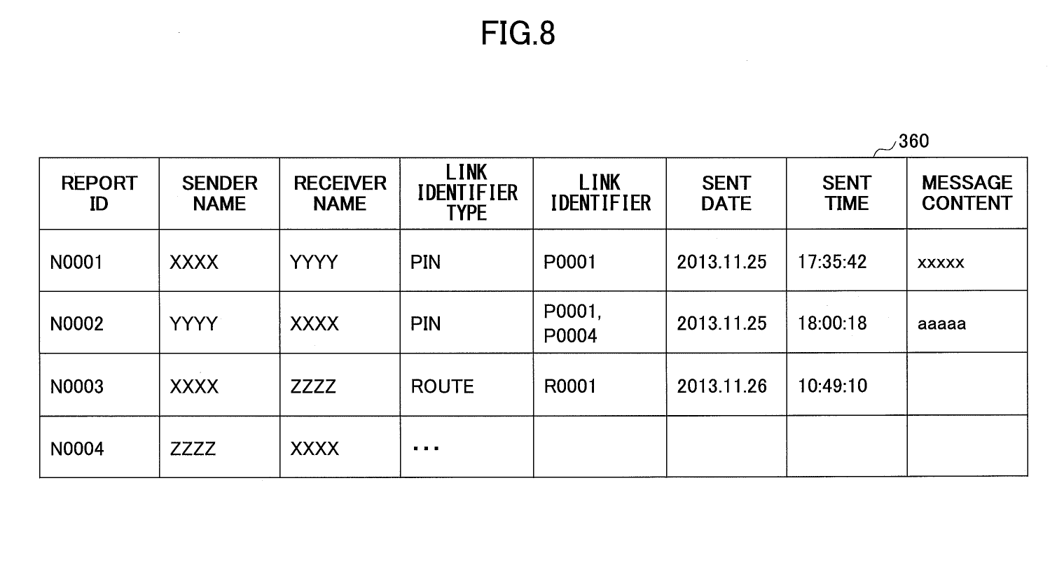

FIG. 8 is a table illustrating an example of the report database 360. The report database 360 includes, as information items (fields), a report (message) ID; and a sender name, a receiver name, a link identifier type, a link identifier, a sent date, a sent time, and a message content that are associated with the report ID. In the descriptions below, information items associated with a report ID in the report database 360 are referred to as “report information”.

The report ID is identification information assigned to each report sent from the terminal 200A to the terminal 200B. The sender name is the name of a sender who has sent a report, and the receiver name is the name of a receiver who has received the report. The sender is, for example, an inspector who performs inspection using the terminal 200A. The receiver is, for example, an inspector who performs inspection using the terminal 200B. Instead of actual names of the sender and the receiver, information such as IDs or email addresses usable to identify the sender and the receiver may be stored in the sender name and receiver name fields.

The link identifier type indicates whether a link identifier in a report is represented by an ID of an inspection pin or an ID of an inspection route.

The link identifier identifies inspection results. For example, depending on the link identifier type, the link identifier is represented by either a pin ID of an inspection pin or a route ID of an inspection route.

The sent date indicates a date on which a message is sent by the sender to the receiver, and the sent time indicates a time when the message is sent. The message content is the content of a message (report) such as text data.

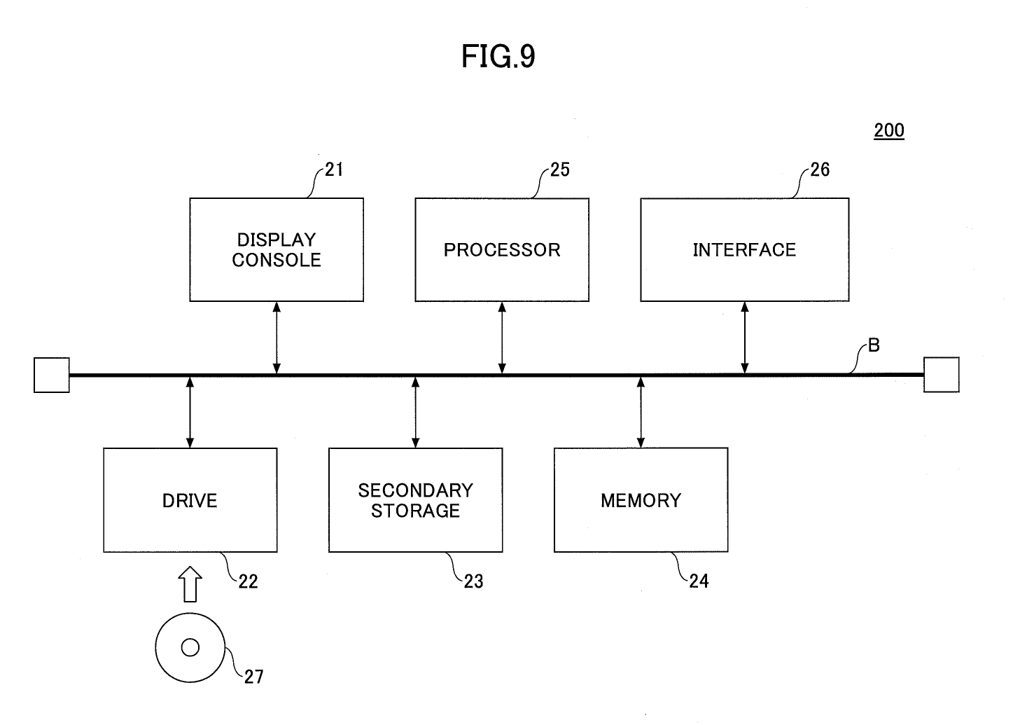

Next, an exemplary hardware configuration of the terminal 200 is described with reference to FIG. 9. FIG. 9 is a block diagram illustrating an exemplary hardware configuration of the terminal 200.

The terminal 200 may include a display console 21, a drive 22, a secondary storage 23, a memory 24, a processor 25, and an interface 26 that are connected to each other via a bus B.

The display console 21 may be implemented by, for example, a touch panel and includes a display function and an information input function. The interface 26 includes, for example, a modem and a LAN card, and is used to connect the terminal 200 to a network.

The terminal 200 may include a facility inspection support program that is one of programs for controlling the terminal 200. For example, the facility inspection support program may be provided via a storage medium 27 or downloaded from a network. Examples of the storage medium 27 for storing the facility inspection support program include storage media such as a compact disk read-only memory (CD-ROM), a flexible disk, and a magneto-optical disk that record information optically, electrically, or magnetically; and semiconductor memories such as a read-only memory (ROM) and a flash memory that record information electrically.

When the storage medium 27 storing the facility inspection support program is set on the drive 22, the facility inspection support program is read by the drive 22 from the storage medium 27 and installed in the secondary storage 23. On the other hand, when the facility inspection support program is downloaded from a network, the facility inspection support program is installed via the interface 26 in the secondary storage 23.

The secondary storage 23 stores the installed facility inspection support program and other necessary files and data. The memory 24 stores the facility inspection support program read from the secondary storage 23 when the terminal 200 (or a computer) is started. The processor 25 executes the facility inspection support program stored in the memory 24 to perform various processes described later.

The terminal 200 may be implemented by, for example, a tablet computer. The server 300 may be implemented by, for example, a general-purpose computer including a processor and a memory.

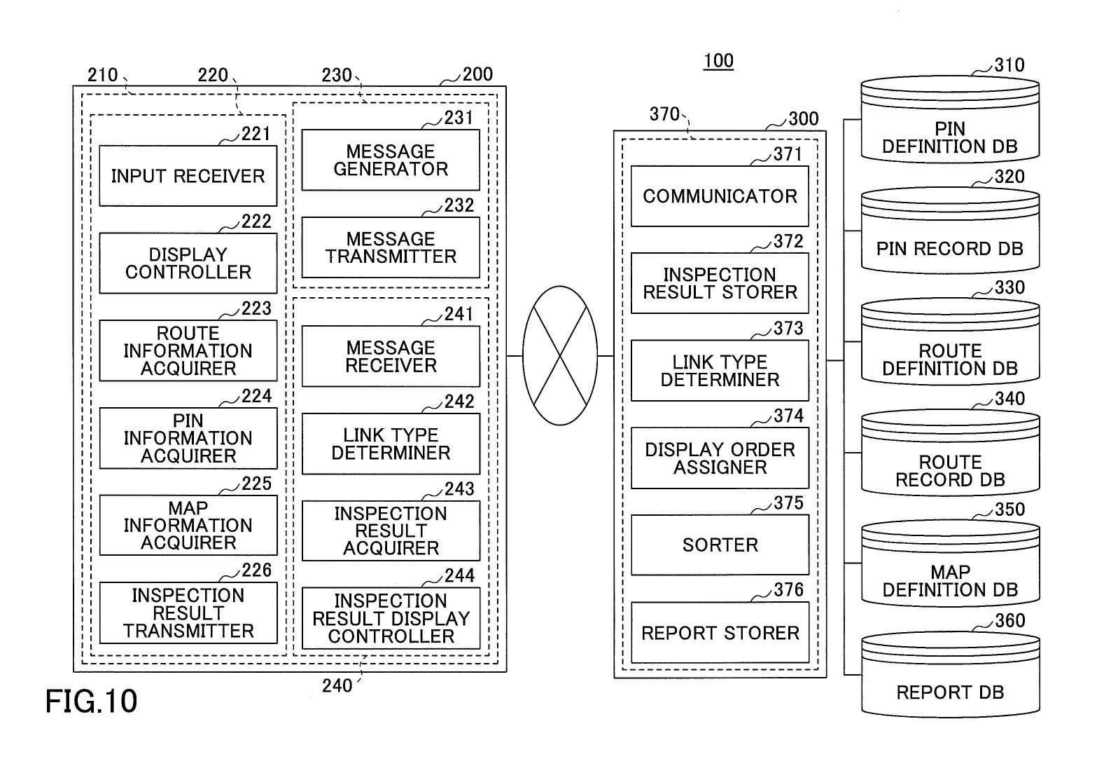

Next, an exemplary functional configuration of the facility inspection support system 100 is described with reference to FIG. 10. FIG. 10 is a drawing illustrating an exemplary functional configuration of the facility inspection support system 100.

A facility inspection support program 210 is installed in the terminal 200. The terminal 200 executes the facility inspection support program 210 to implement various functional units and perform various processes described below. The terminal 200 may include an input support unit 220 for supporting entry of inspection results, a reporting unit 230 for reporting inspection results to another terminal 200, and a result display unit 240 for displaying inspection results based on a report received from another terminal 200.

The input support unit 220 may include an input receiver 221, a display controller 222, a route information acquirer 223, a pin information acquirer 224, a map information acquirer 225, and an inspection result transmitter 226.

The input receiver 221 receives various inputs or instructions via the display console 21. The display controller 222 controls display of information on the display console 21.

The route information acquirer 223 obtains route information from the route definition database 330 based on an input received by the input receiver 221. The pin information acquirer 224 obtains pin information from the pin definition database 310 based on an input received by the input receiver 221. The map information acquirer 225 obtains map information from the map definition database 350 based on map IDs included in the pin information.

The inspection result transmitter 226 sends inspection results to the server 300 when inspection of a selected inspection route is completed.

The reporting unit 230 may include a message generator 231 and a message transmitter 232. When one or more link identifiers indicating inspection results to be reported and a destination to which the inspection results are reported are selected at the terminal 200, the message generator 231 generates a message including the selected link identifiers.

The message transmitter 232 sends the message generated by the message generator 231 to the server 300.

The result display unit 240 may include a message receiver 241, a link type determiner 242, an inspection result acquirer 243, and an input result display controller 244.

The message receiver 241 receives a message via the server 300 from another terminal 200. Here, receiving a message indicates receiving a report of inspection results from another terminal 200.

The link type determiner 242 refers to the report database 360 based on link identifiers in the message and determines the types of the link identifiers. The inspection result acquirer 243 obtains inspection results from the server 300 based on the link identifiers. The inspection result display controller 244 displays the obtained inspection results according to display order indicators assigned to the inspection results.

An inspection result providing program 370 is installed in the server 300. The server 300 executes the inspection result providing program 370 to implement various functional units and perform various processes described below.

The server 300 may include a communicator 371, an inspection result storer 372, a link type determiner 373, a display order assigner 374, a sorter 375, and a report storer 376.

The communicator 371 communicates with the terminal 200. The inspection result storer 372 updates the route record database 340 based on inspection results sent from the terminal 200, and stores the inspection results in the pin record database 320.

More specifically, the inspection result storer 372 sets “completed” in the status field of a record in the route record database 340 corresponding to the route ID of an inspection route whose inspection is completed, assigns a route record ID to the inspection results, and stores the route record ID in association with the route ID.

Also, the inspection result storer 372 stores, in the pin record database 320, input values of input items of each inspection pin and the date and time when the input values are entered. Further, the inspection result storer 372 stores the route record ID, which is stored in association with the route ID in the route record database 340, in association with pin IDs in the pin record database 320.

The link type determiner 373 determines the types of link identifiers. The display order assigner 374 assigns display order indicators to link identifiers. The display order indicators indicate the order in which the link identifiers (or inspection results corresponding to the link identifiers) are displayed at the terminal 200. The sorter 375 reorders the link identifiers in the report database 360 according to the assigned display order indicators.

The report storer 376 assigns a report ID to a message received from the terminal 200, and stores the message in the report database 360 in association with the report ID. More specifically, the report storer 376 extracts information items corresponding to the fields of the report database 360 from the received message, and stores the extracted information items in the corresponding fields of the report database 360. Also, the report storer 376 stores link identifiers in the report database 360 in the order reordered by the sorter 375.

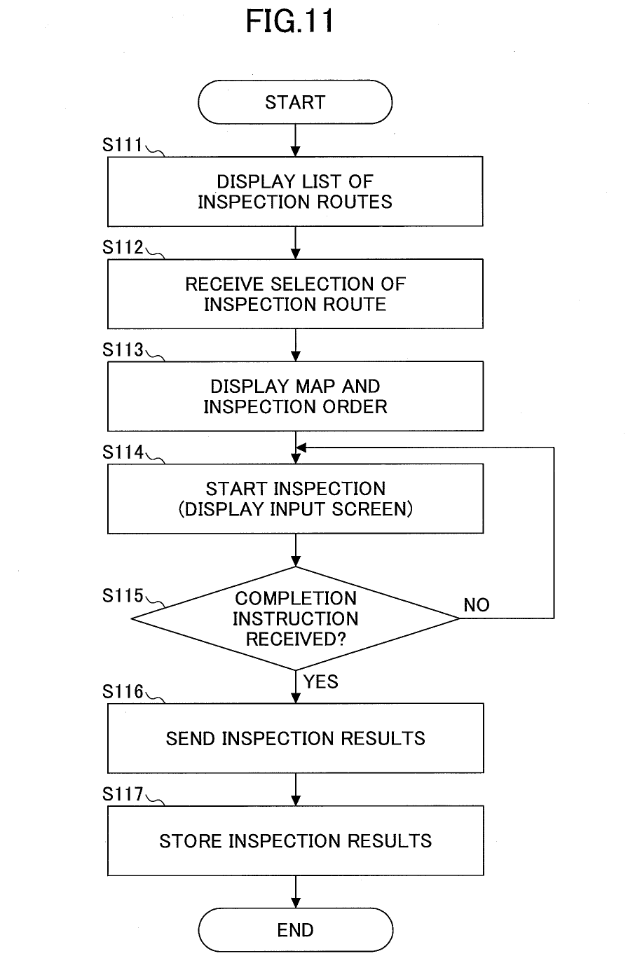

Next, an exemplary process performed by the terminal 200 and the server 300 is described with reference to FIG. 11. FIG. 11 is a flowchart illustrating an exemplary process performed by the terminal 200 and the server 300 from the start to the end of inspection.

When inspection is started, the route information acquirer 223 of the terminal 200 obtains a list of inspection routes from the route definition database 330, and the display controller 222 displays the list of inspection routes on the display console 21 (step S111). Next, the input receiver 221 receives a selection of an inspection route (step S112).

Then, the terminal 200 displays a map including inspection points and the order of inspection based on the selected inspection route (step S113).

Step S113 is described in more detail below. When an inspection route is selected, the route information acquirer 223 obtains route information of the selected inspection route from the route definition database 330. Next, the pin information acquirer 224 refers to the pin definition database 310 and obtains pin information corresponding to pin IDs in the route information. Then, the map information acquirer 225 obtains map information corresponding to map IDs in the pin information from the map definition database 350.

In step S113 of the process of the present embodiment, a map ID included in pin information corresponding to a pin ID at the top of pin IDs in the route information may be obtained, and a map may be displayed based on map information corresponding to the obtained map ID. With this method, the terminal 200 can display a map including an inspection pin indicating the first inspection point in the inspection route.

The terminal 200 may also display the order of inspection of inspection pins according to the order in which pin IDs are arranged in the obtained route information.

Following step S113, the terminal 200 starts supporting inspection work of an inspector (step S114).

More specifically, the terminal 200 displays an input screen including an input field(s) corresponding to an input item(s) for each inspection pin, and receives a value(s) entered in the input field(s). The terminal 200 retains the received value as an inspection result.

The terminal 200 can also display an input screen corresponding to the next inspection pin or an input screen corresponding to the previous inspection pin according to an input screen switch instruction. Further, when, for example, an inspection pin is set at an inspection point not included in an inspection route, the terminal 200 inserts the inspection pin in the inspection route.

With the above functions, for example, even when it is difficult or inappropriate to continue inspection in a predetermined order, the terminal 200 enables the inspector to continue inspection by changing the order of inspection.

Next, the terminal 200 determines whether a completion report (or completion instruction) indicating completion of the inspection has been received (step S115). When it is determined at step S115 that the completion report has not been received, the terminal 200 returns to step S114. When it is determined at step S115 that the completion report has been received, the terminal 200 sends inspection results to the server 300 (step S116).

When receiving the inspection results, the inspection result storer 372 of the server 300 updates the route record database 340, and stores the inspection results in the pin record database 320 (step S117).

After the completion report is received, the terminal 200 does not switch input screens even when an input screen switch instruction is received. Also after receiving the completion report, the terminal 200 does not accept entry of inspection results.

Thus, according to the present embodiment, entry of inspection results is prevented after a completion report indicating completion of inspection is received. This configuration makes it possible to prevent tampering of inspection results.

The terminal 200 may also be configured to prevent transmission of inspection results to the server 300 before a completion report is received.

Next, an exemplary process of sharing inspection results in the facility inspection support system 100 is described. In the facility inspection support system 100, the terminal 100 reports inspection results to another terminal 100 to share the inspection results.

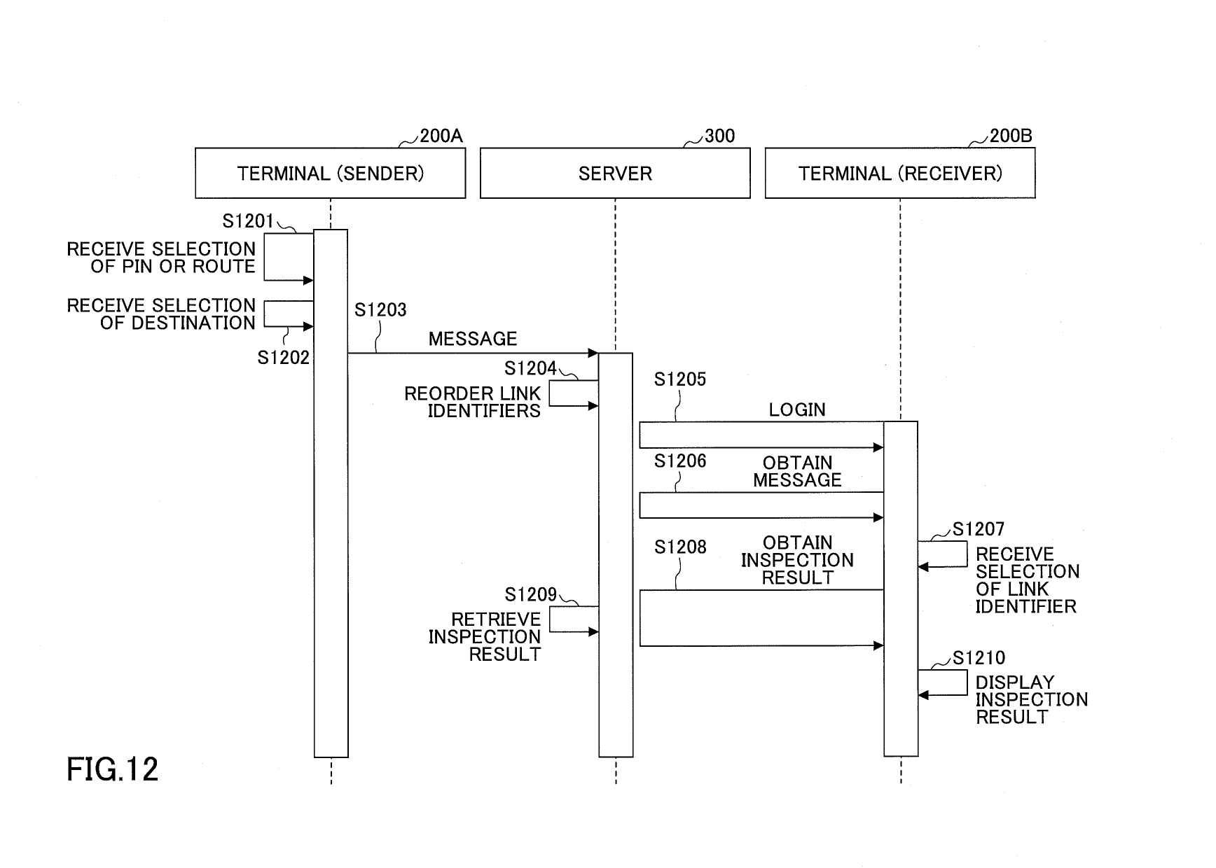

FIG. 12 is a sequence chart illustrating an exemplary process of sharing inspection results.

In the facility inspection support system 100, the input receiver 221 of the terminal 200A used by a sender receives a selection of one or more inspection pins or an inspection route whose inspection results are to be shared (step S1201). Next, the input receiver 221 of the terminal 200A receives a selection of a destination to which a message is to be sent (step S1202).

Then, the message generator 231 of the terminal 200A generates a message including one or more link identifiers identifying the selected inspection pins or inspection route, and the message transmitter 232 sends the message to the server 300 (step S1203). At this step, the message generator 231 generates the message such that the link identifiers are arranged in the message in the order they are selected. In the present embodiment, a link identifier is, for example, a pin ID of a selected inspection pin or a route ID of a selected inspection route.

When the message including the link identifiers is received from the terminal 200A, the link type determiner 373 of the server 300 determines the type of the link identifiers. When the type of the link identifiers is “pin”, the server 300 reorders the link identifiers (step S1204). Then, the report storer 376 of the server 300 stores the message in the report database 360.

More specifically, the server 300 reorders the link identifiers, which are arranged in the order they are selected, according to the corresponding inspection route. Details of step S1204 are described later.

In the facility inspection support system 100, the server 300 receives a login request from the terminal 200B (step S1205). After logging into the server 300, the terminal 200B obtains a message including link identifiers from the report database 360 of the server 300 (step S1206). Here, the link identifiers in the message obtained by the terminal 200B have been reordered by the server 300.

Next, the input receiver 221 of the terminal 200B receives a selection of a link identifier in the message (step S1207). The terminal 200B sends the selected link identifier to the server 300 to obtain an inspection result corresponding to the link identifier (step S1208).

When the link identifier is received from the terminal 200B, the server 300 sends an inspection result corresponding to the link identifier to the terminal 200B (step S1209). The terminal 200 displays the obtained inspection result (step S1210). Details of step S1210 are described later.

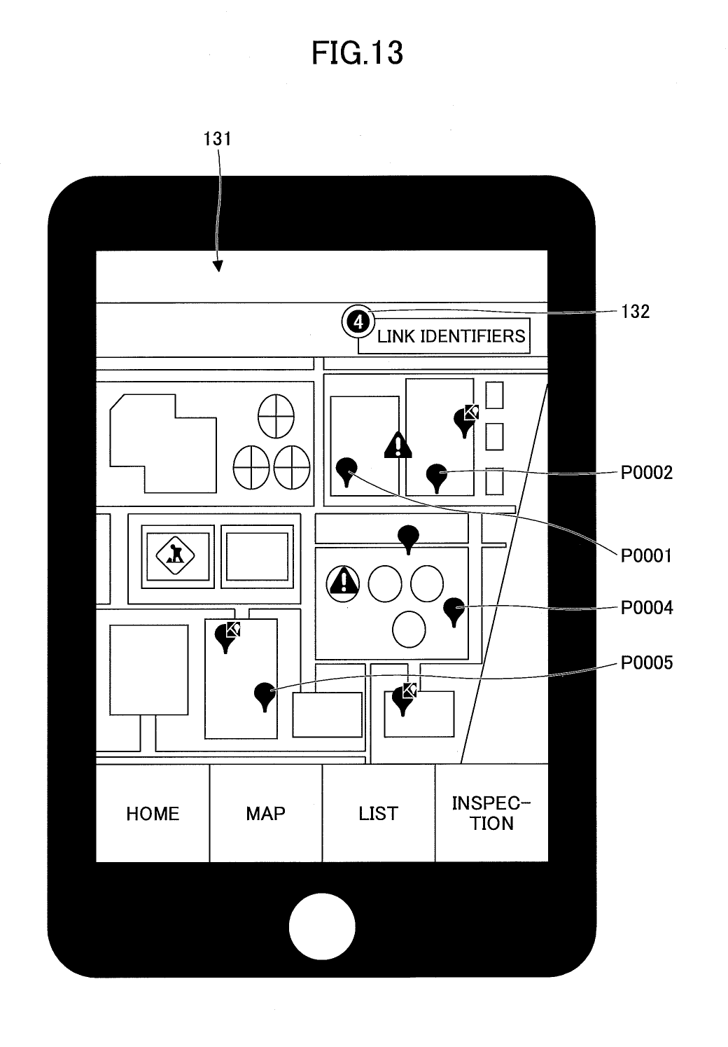

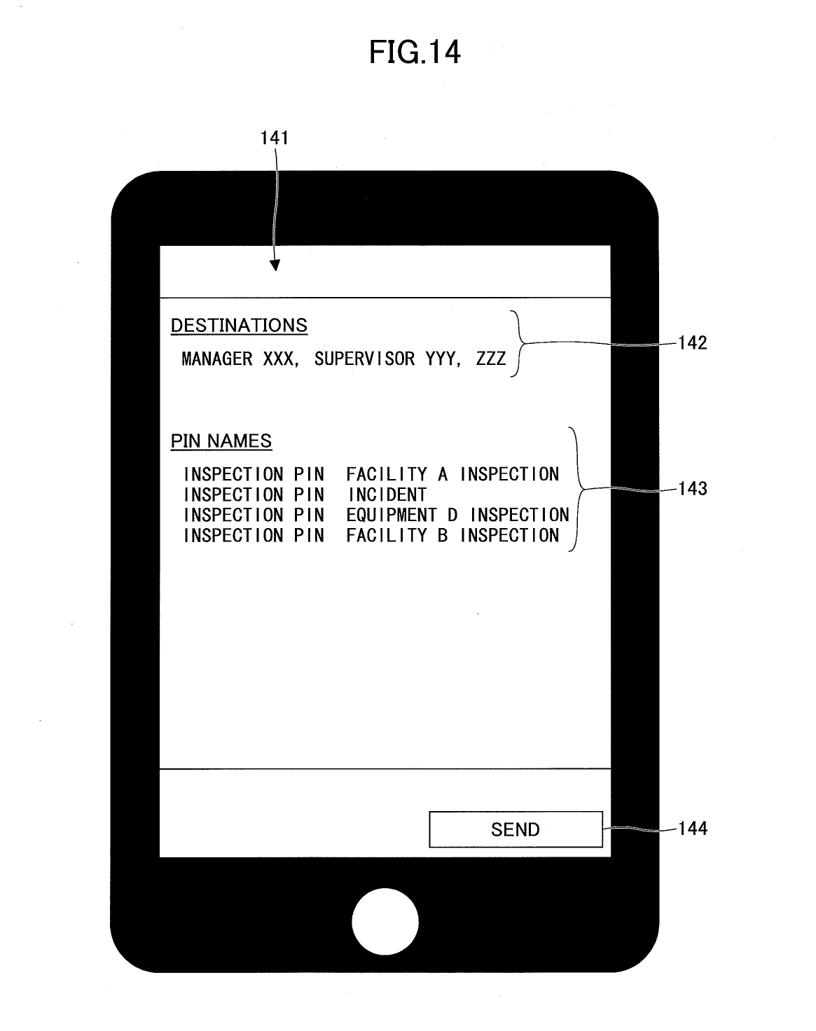

Next, an exemplary process of generating a message by the terminal 200A is described with reference to FIGS. 13 and 14. In this exemplary process, it is assumed that the terminal 200A generates a message to share inspection results of inspection pins.

FIG. 13 is a drawing illustrating an exemplary pin selection screen 131 displayed on the terminal 200A. In the pin selection screen 131 of FIG. 13, hierarchical pins and inspection pins are displayed on a map according to an inspection route. The pin selection screen 131 also includes a report icon 132 indicating that there are inspection pins selected to be included in a message.

On the pin selection screen 131, an inspection pin whose inspection result is to be shared can be selected by dragging the inspection pin to the report icon 132.

In the example of FIG. 13, it is assumed that an inspection pin “P0001”, an inspection pin “P0005”, an inspection pin “P0004”, and an inspection pin “P0002” are selected in this order.

FIG. 14 is a drawing illustrating an exemplary message screen 141 displayed on the terminal 200A. In the message screen 141, destinations 142 of a message and pin names 143 of selected inspection pins are displayed. The pin names 143 are displayed in the order the inspection pins are selected on the pin selection screen 131.

The message screen 141 indicates that the inspection pin “P0001” with a name “facility A inspection”, the inspection pin “P0005” with a name “incident”, the inspection pin “P0004” with a name “equipment D inspection”, and the inspection pin “P0002” with a name “facility B inspection” are selected in this order.

The message transmitter 232 of the terminal 200A sends a message including link identifiers represented by the pin IDs of the selected inspection pins to the server 300. The pin IDs are arranged in the message in the order the inspection pins are selected.

When receiving the message including the link identifiers, the server 300 reorders the link identifiers according to the corresponding inspection route, and stores the reordered link identifiers in the report database 360. Reordering link identifiers enables the terminal 200B to display the link identifiers in the order along the inspection route.

Accordingly, an inspector using the terminal 200B can refer to the inspection results in the order along the inspection route.

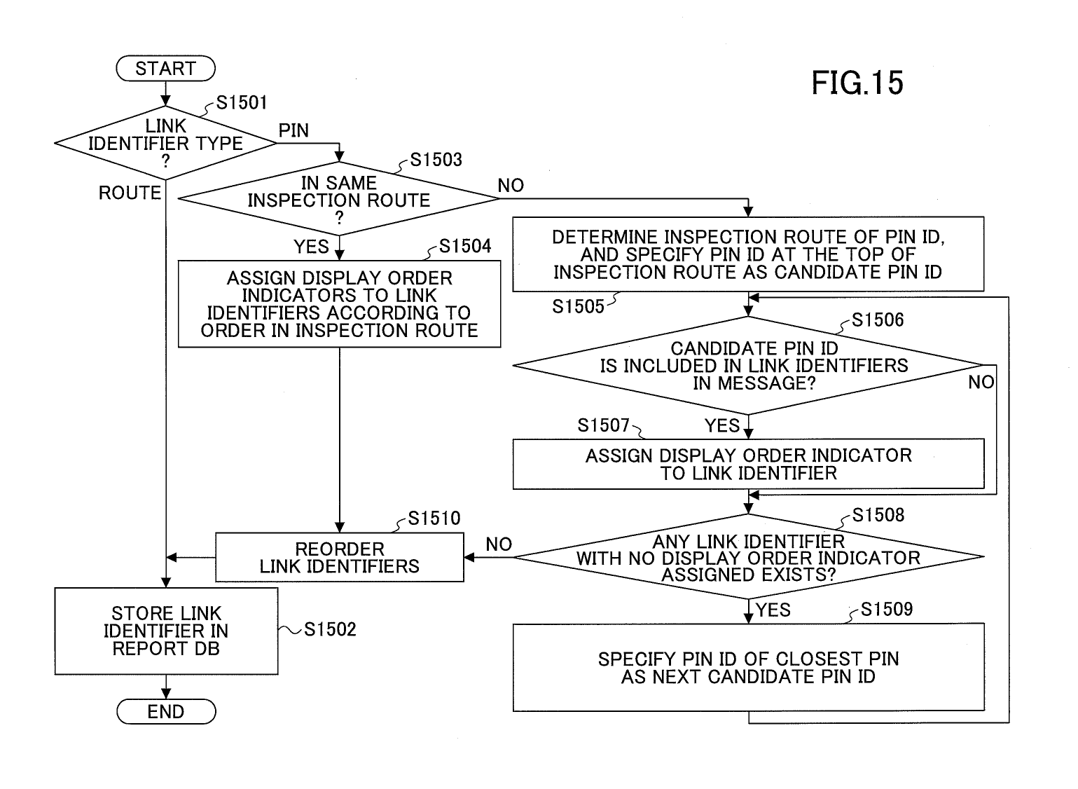

Next, an exemplary process of reordering link identifiers by the server 300 is described. FIG. 15 is a flowchart illustrating an exemplary process of reordering link identifiers.

When a message is received from the terminal 200A, the link type determiner 373 of the server 300 determines whether the type of a link identifier(s) in the message is “pin” or “route” (step S1501). More specifically, the link type determiner 373 determines whether the message includes link identifiers represented by pin IDs of inspection pins or a link identifier represented by an route ID of an inspection route.

When it is determined at step S1501 that the message includes a link identifier represented by a route ID of an inspection route, the report storer 376 stores the link identifier in the report database 360 in association with a report ID (step S1502).

When it is determined at step S1501 that the message includes link identifiers represented by pin IDs of inspection pins, the display order assigner 374 determines whether all the pin IDs in the message are included in the same inspection route (step S1503). When it is determined at step S1503 that all the pin IDs are included in the same inspection route, the display order assigner 374 assigns display order indicators to the pin IDs (link identifiers) according to the order in which the pin IDs are registered in the inspection route (step S1504). Then, the server 300 proceeds to step S1510. At step S1510, the sorter 375 reorders the link identifiers according to the assigned display order indicators. In this case, at step S1502, the report storer 376 stores the reordered link identifiers in the report database 360.

When it is determined at step S1503 that not all the pin IDs are included in the same inspection route, the message includes pin IDs selected from different inspection routes. In this case, the display order assigner 374 of the server 300 selects a pin ID from the pin IDs in the message, determines an inspection route including the selected pin ID, and specifies a pin ID of an inspection pin at the top of the determined inspection route as a candidate pin ID (step S1505).

Next, the display order assigner 374 determines whether the candidate pin ID is included in the link identifiers in the message (step S1506).

When it is determined at step S1506 that the candidate pin ID is included in the link identifiers in the message, the display order assigner 374 assigns an display order indicator to the link identifier corresponding to the candidate pin ID (step S1507). For example, the assigned display order indicator may be “1” indicating the first place in the display order. After the display order indicator is assigned, the display order indicator is incremented by one and stored.

Next, the display order assigner 374 determines whether one or more link identifiers to which no display order identifier has been assigned are left in the message (or determines whether display order indicators have been assigned to all of the link identifiers in the message) (step S1508).

When it is determined at step S1508 that one or more link identifiers to which no display order identifier has been assigned are left in the message, the display order assigner 374 determines, on a map including an “order-assigned” inspection pin corresponding to the link identifier (pin ID) to which the display order identifier has been assigned at step S1507, a closest pin closest in distance to the order-assigned inspection pin, and specifies the pin ID of the closest pin as a next candidate pin ID (step S1509). Then, the process returns to step S1506.

When it is determined at step S1508 that display order indicators have been assigned to all of the link identifiers in the message, the process proceeds to step S1510. At step S1510, the sorter 375 reorders the link identifiers according to the assigned display order indicators. In this case, at step S1502, the report storer 376 stores the reordered link identifiers in the report database 360.

Step S1509 is described in more detail below.

The map including the order-assigned inspection pin may include inspection pins and hierarchical pins included in the same inspection route as that including the order-assigned inspection pin. The map including the order-assigned inspection pin may also include inspection pins that correspond to link identifiers in the message but are included in an inspection route different from the inspection route including the order-assigned inspection pin.

For the above reason, the display order assigner 374 obtains a positional relationship between the order-assigned inspection pin and three types of pins described below on the map including the order-assigned inspection pin, and specifies the pin ID of one of the three types of pins that is closest to the order-assigned inspection pin as a next candidate pin ID. The positional relationship between the order-assigned inspection pin and the three types of pins can be obtained based on, for example, coordinates of those pins stored in the pin definition database 310 in association with the corresponding pin IDs.

Among the three types of pins, a first type of pin is an inspection pin that is included in the same inspection route as the order-assigned inspection pin, and is in a position after and closest to the order-assigned inspection pin in the order of inspection. A second type of pin is a hierarchical pin that is on the map including the order-assigned inspection pin. A third type of pin is an inspection pin that corresponds to a link identifier in the message, is included in an inspection route different from the inspection route including the order-assigned inspection pin, and is included in the same map including the order-assigned inspection pin.

In the process of the present embodiment, the pin ID of one of the three types of pins closest in distance to the order-assigned inspection pin is placed after the pin ID of the order-assigned pin ID so that link identifiers can be displayed in an order similar to the order of inspection in an inspection route. Alternatively, the pin ID of one of the three types of pins closest in distance to the order-assigned inspection pin may be placed before the pin ID of the order-assigned pin ID.

As described above, the present embodiment makes it possible to display pins on a message screen of a receiving terminal in an order similar to the order of inspection in an inspection route regardless of the order in which the pins are selected on a map by the sender.

As an example, assume a case where the order of inspection in an inspection route including inspection pins “P0001” through “P0005” is the ascending order of the pin IDs, and the inspection pins “P0001”, “P0005”, “P0004”, and “P0002” are selected in this order at the sending terminal. Even in this case, the receiving terminal can display a message from the sending terminal such that link identifiers corresponding to the selected inspection pins are arranged in the order of “P0001”, “P0002”, “P0004”, and “P0005” that matches the order of inspection in the inspection route.

Also, the present embodiment makes it possible to display a link identifier corresponding to a “non-included” inspection pin not included in an inspection route before or after a link identifier corresponding to one of inspection pins in the inspection route which is closest to the non-included inspection pin.

Thus, in the present embodiment, it is possible for a receiver of a message to display link identifiers in the message in an order that substantially matches the order of inspection in an inspection route.

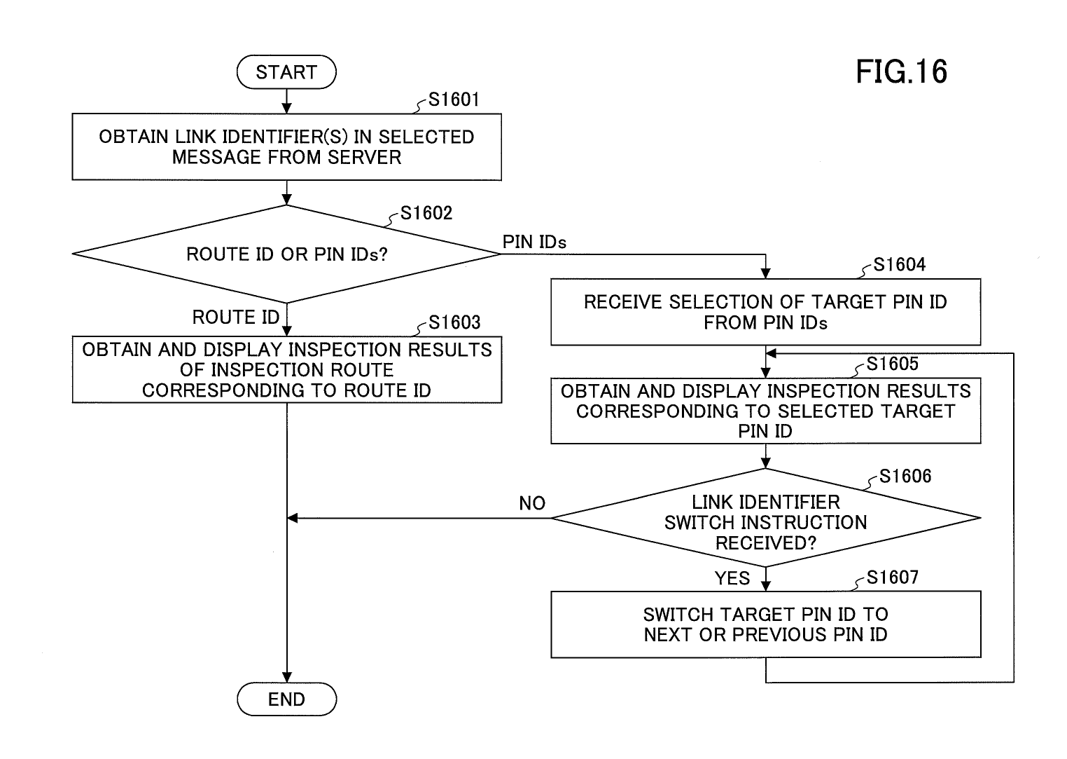

Next, an exemplary process of displaying inspection results by the terminal 200B is described. FIG. 16 is a flowchart illustrating an exemplary process of displaying inspection results.

When a selection of a displayed message is received by the input receiver 221, the terminal 200B obtains a link identifier(s) included in the selected message from the server 300 (step S1601).

Next, the link type determiner 242 determines whether the obtained link identifier(s) is a route ID of an inspection route or pin IDs of inspection pins (step S1602). When it is determined at step S1602 that the obtained link identifier is a route ID, the inspection result acquirer 243 obtains inspection results of an inspection route corresponding to the route ID from the server 300, and the inspection result display controller 244 displays an inspection result screen including the obtained inspection results (step S1603).

When it is determined at step S1602 that the obtained link identifiers are pin IDs, the input receiver 221 receives a selection of a target pin ID from the pin IDs for which inspection results are to be displayed (step S1604).

In the present embodiment, it is assumed that the obtained pin IDs have been reordered by the server 300.

Next, the inspection result acquirer 243 obtains inspection results corresponding to the selected target pin ID from the server, and the inspection result display controller 244 displays an inspection result screen including the obtained inspection results (step S1605).

Next, the input receiver 221 determines whether a link identifier switch instruction has been entered on the inspection result screen (step S1606). The link identifier switch instruction is an instruction to switch pin IDs for which inspection results are displayed.

When it is determined at step S1606 that a link identifier switch instruction has been entered, the terminal 200B switches the target pin ID to a pin ID preceding or succeeding the target pin ID in the order the pin IDs are arranged in the message (step S1607), and returns to step S1605.

When it is determined at step S1606 that no link identifier switch instruction has been entered, the terminal 200B closes the inspection result screen and ends the process.

As described above, in the present embodiment, it is possible to switch inspection pins in a message and thereby switch inspection result screens in an order that matches the order of inspection in an inspection route. As an example, assume a case where pin IDs corresponding to inspection pins “P0001”, “P0003”, and “P0005” selected from inspection pins “P0001” through “P0005” in an inspection route are included in a message, and the pin ID of the inspection pin “P0001” is selected as a target pin ID. In this case, the terminal 200B displays an inspection result screen including inspection results of the inspection pin P0001. Then, when a link identifier switch instruction is entered on the inspection result screen, the terminal 200B displays an inspection result screen including inspection results of the inspection pin P0003.

Thus, in the present embodiment, it is possible for a receiver of a message to switch inspection result screens in an order that substantially matches the order of inspection in an inspection route.

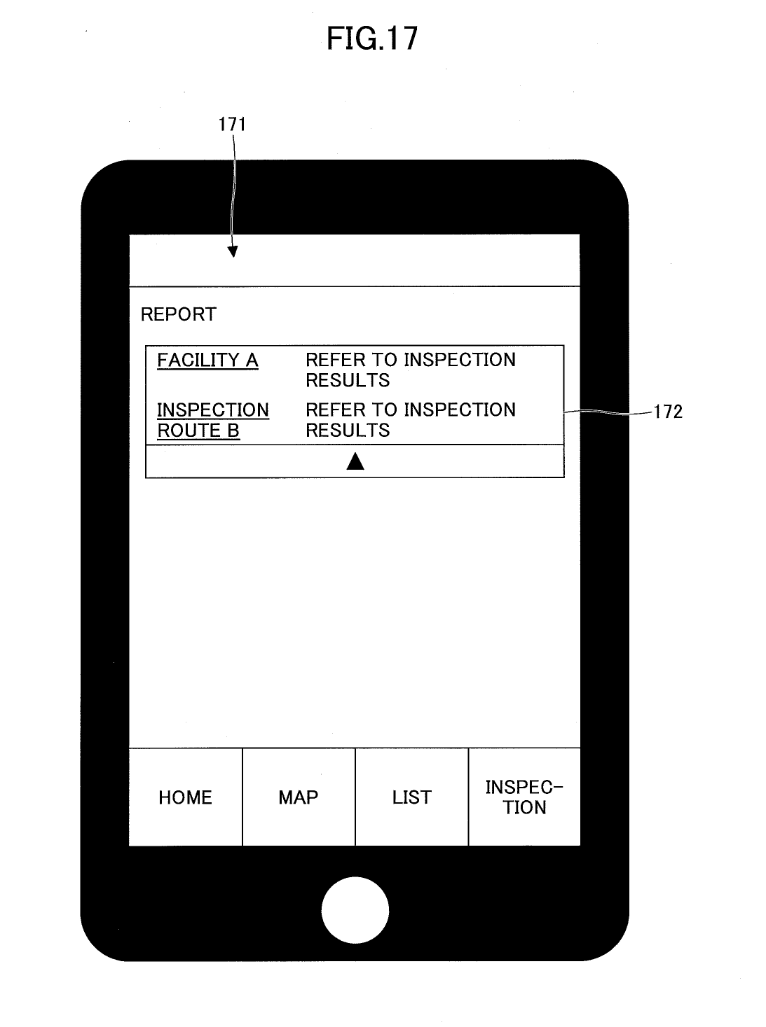

Next, the process of displaying inspection results is further described with reference to FIGS. 17 through 19. FIG. 17 is a drawing illustrating an exemplary message reception screen 171.

The message reception screen 171 of FIG. 17 is displayed when, for example, the terminal 200B is logged into the facility inspection support system 100, and indicates whether any message is received from the terminal 200A.

The message reception screen 171 includes a report field 172 that displays a list of messages (if any) stored in the report database 360 of the server 300 for the terminal 200B. The process of FIG. 16 may be started when a title of a message in the report field 172 is selected at the terminal 200B.

For example, when a message “facility A” in the report field 172 is selected, the terminal 200B obtains link identifiers included in the message from the report database 360 of the server 300, and starts the process of displaying inspection results.

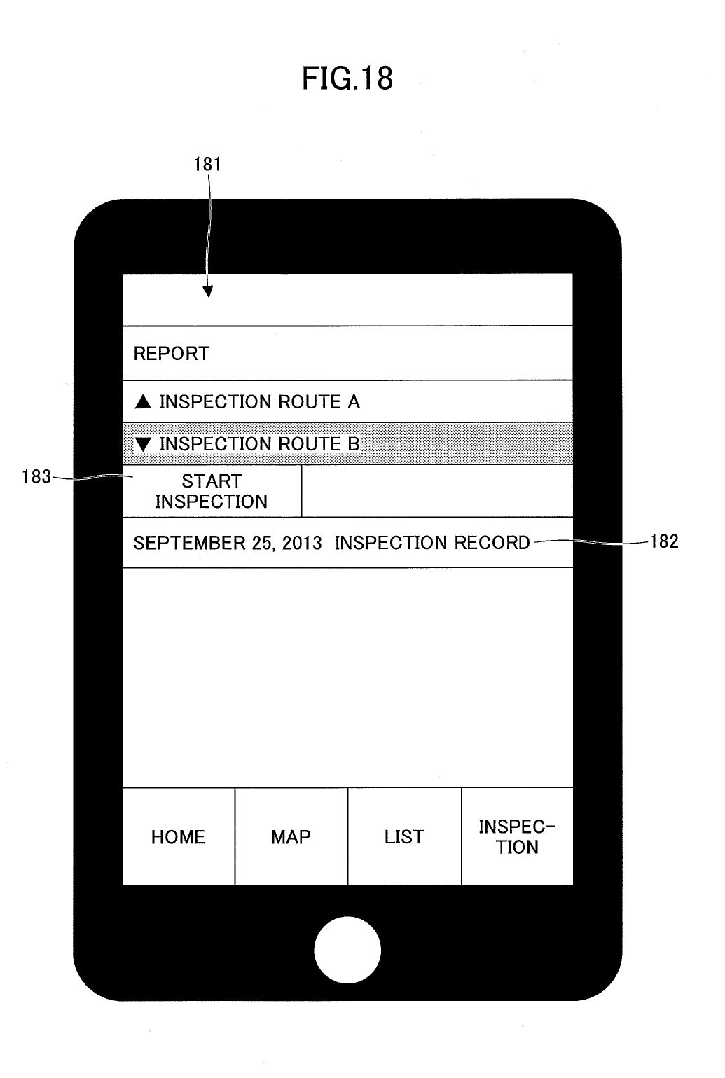

FIG. 18 is a drawing illustrating an exemplary inspection result screen 181 displayed when a link identifier is a route ID indicating an inspection route.

The inspection result screen 181 of FIG. 18 is based on an assumption that an inspection route B is selected on the message reception screen 171 of FIG. 17. The inspection result screen 181 includes a button 182 for displaying details of inspection results of the inspection route B. The inspection result screen 181 also includes an inspection start button 183 for switching the inspection result screen 181 to a screen for starting inspection of the inspection route B.

For example, when the inspection start button 183 is pressed, the terminal 200B may display an input screen for the first inspection pin in the order of inspection in the inspection route B.

Providing the inspection start button 183 on the inspection result screen 181 makes it possible to restart the inspection of an inspection route by referring to shared inspection results.

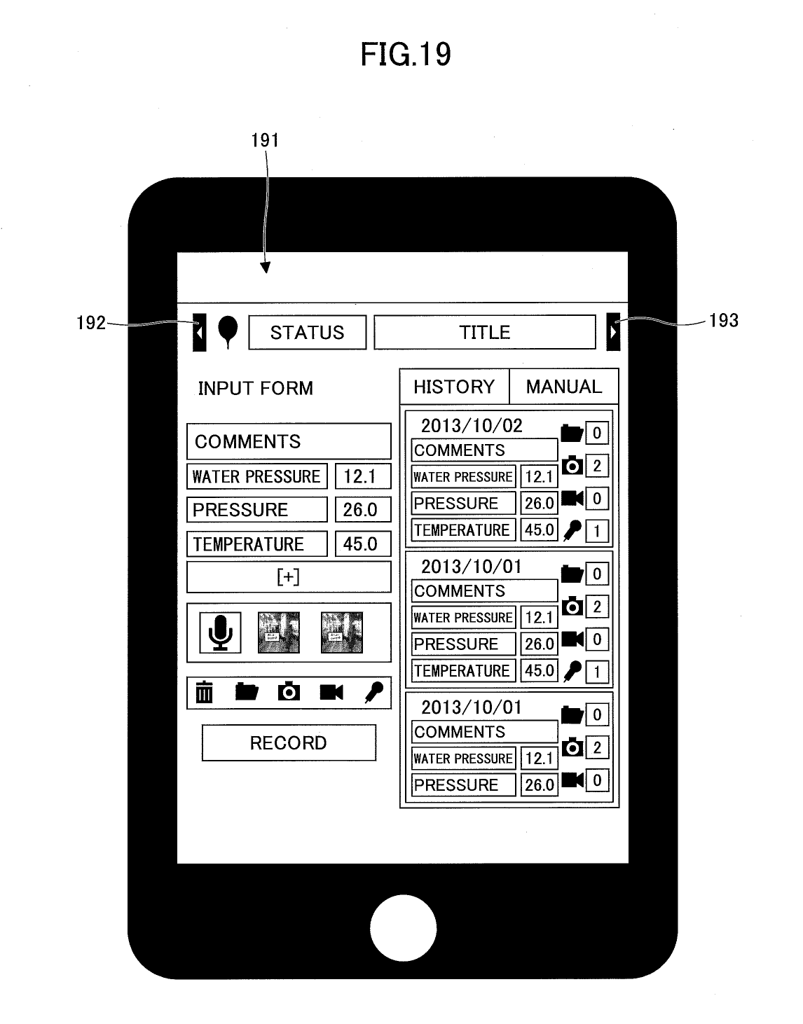

FIG. 19 is a drawing illustrating an exemplary inspection result screen 191 displayed when link identifiers are pin IDs indicating inspection pins.

The inspection result screen 191 of FIG. 19 displays inspection results of an inspection pin corresponding to a pin ID selected as a target pin ID from pin IDs in a message at the terminal 200B.

The inspection result screen 191 also includes switch buttons 192 and 193 for switching inspection result screens. For example, when the switch button 192 is pressed, the terminal 200B switches the inspection result screen 191 to an inspection result screen displaying inspection results of an inspection pin corresponding to a pin ID preceding the target pin ID in the order the pin IDs are arranged in the message. On the other hand, when the switch button 193 is pressed, the terminal 200B switches the inspection result screen 191 to an inspection result screen displaying inspection results of an inspection pin corresponding to a pin ID succeeding the target pin ID in the order the pin IDs are arranged in the message.

As described above, in the present embodiment, an inspector is enabled to generate a message including link identifiers for accessing the latest inspection results of facilities and inspection routes by simply specifying the facilities and the inspection routes. Accordingly, in the present embodiment, it is possible to support collaborative inspection work where multiple inspectors take turns to perform inspection of facilities.

An aspect of this disclosure makes it possible to provide a storage medium, a facility inspection support method, and a facility inspection support apparatus that can support collaborative inspection work.

All examples and conditional language provided herein are intended for the pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a program that causes a computer to execute a process comprising:
displaying pointers indicating inspection points on a map of a facility;
receiving an operation that selects one or more of the displayed pointers;
when multiple pointers are selected from the displayed pointers, generating a message including link identifiers for separately referring to inspection results associated with the selected multiple pointers respectively; and
sending the generated message to a specified destination.

2. The non-transitory computer-readable storage medium as claimed in claim 1, wherein the link identifiers in the message are arranged in an order corresponding to an order of inspection defined for the selected multiple pointers.

3. The non-transitory computer-readable storage medium as claimed in claim 2, wherein when the selected multiple pointers include order-defined pointers for which the order of inspection is defined and an order-undefined pointer for which the order of inspection is not defined, the order-defined pointers are arranged in the message in the order corresponding to the order of inspection, and the order-undefined pointer is placed in the message immediately before or after one of the order-defined pointers that is closest to the order-undefined pointer.

4. A non-transitory computer-readable storage medium storing therein a program that causes a computer to execute a process comprising:
displaying a message including link identifiers for separately referring to inspection results associated with pointers indicating inspection points on a map of a facility, the pointers being included in an inspection route defining an order of inspection of the pointers;
receiving an operation that selects a first link identifier of the link identifiers in the displayed message;
displaying an inspection result screen including an inspection result associated with a first pointer of the pointers that corresponds to the first link identifier; and
in response to a switch instruction on the inspection result screen, switching the inspection result screen to another inspection result screen including an inspection result associated with a second pointer of the pointers that corresponds to a second link identifier of the link identifiers in the message according to the order of inspection of the pointers.

5. A non-transitory computer-readable storage medium storing therein a program that causes a computer to execute a process comprising:
receiving an operation that selects an inspection route including multiple inspection points on a map of a facility and defining an order of inspection of the multiple inspection points;
generating a message including a link identifier for displaying a screen including an interface for receiving an instruction to start entry of inspection results of the multiple inspection points in the inspection route; and
sending the generated message to a specified destination.

6. A computer-implemented method, comprising:
displaying pointers indicating inspection points on a map of a facility;
receiving an operation that selects one or more of the displayed pointers;
when multiple pointers are selected from the displayed pointers, generating a message including link identifiers for separately referring to inspection results associated with the selected multiple pointers respectively; and
sending the generated message to a specified destination.

7. A facility inspection support apparatus, comprising:
a processor configured to execute a process including
displaying pointers indicating inspection points on a map of a facility;
receiving an operation that selects one or more of the displayed pointers;
when multiple pointers are selected from the displayed pointers, generating a message including link identifiers for separately referring to inspection results associated with the selected multiple pointers respectively; and
sending the generated message to a specified destination.
